(19) United States
(12) Patent Application Publication
(10) Pub. No.: US 2025/0042785 A1
(43) Pub. Date: Feb. 6, 2025

(54) WATER TREATMENT WITH PHOTOCATALYTIC TECHNOLOGY

(71) Applicant: The Regents of the University of California, Oakland, CA (US)

(72) Inventors: Haizhou Liu, lrvine, CA (US); Cheng Tan, Riverside, CA (US); Xuejun Yu, lrvine, CA (US)

(21) Appl. No.: 18/706,825

(22) PCT Filed: Nov. 2, 2022
(86) PCT No.: PCT/US2022/048697

§ 371 Date: May 2, 2024

Related U.S. Application Data
(60) Provisional application No. 63/274,764, filed on Nov. 2, 2021.

(51) Int. Cl. C02F 1/72; C02F 1/00; C02F 1/32; C02F 1/66; C02F 1/76; C02F 101/20

(52) U.S. Cl. CPC C02F 1/725; C02F 1/001; C02F 1/32; C02F 1/66; C02F 1/76; C02F 2101/20; C02F 2305/023; C02F 2305/10

(57) ABSTRACT

An apparatus and method to oxidize a contaminant entrained in potable water. The method can include a step of adding an amount of at least one of hydrogen peroxide (H₂O₂), hypochlorous acid (HOCl), or chloramine (NH₂Cl) to the potable water to form a solution. The method can include a step of exposing the solution to a source of UV radiation to form a catalyst including at least one of a hydroxyl radical, a reactive chlorine species, or a reactive amine species to oxidize the inorganic contaminant.

### CLAIM OF PRIORITY

This patent application claims the benefit of priority of Liu U.S. Provisional Patent Application Ser. No. 63/274,764, entitled “DEVICES AND METHODS FOR WATER TREATMENT WITH LIGHT EMITTING DIODE (LED) PHOTOCATLYTIC TECHNOLOGY,” filed on Nov. 2, 2021 (Attorney Docket No. 3868.084PRV), which is hereby incorporated by reference herein in its entirety.

### STATEMENT REGARDING FEDERALLY SPONSORED RESEARCH OR DEVELOPMENT

This invention was made with government support under grant 1653931 awarded by the National Science Foundation. The government has certain rights in the invention.

### TECHNICAL FIELD

This document pertains generally, but not by way of limitation, to the elimination of contaminants from water.

### BACKGROUND

Clean water is an important resource for the maintenance and growth of civil society. Rapid urbanization and the impact of climate change create unique challenges to the delivery of clean water, such as to communities sharing a municipal water supply. Municipal water treatment facilities can remove contaminants from water, such as physical contaminants (e.g., sediment, suspended material), organic contaminants (e.g., microorganisms, bacteria, viruses, protozoa, parasites), and chemical (or inorganic) contaminants (e.g., nitrogen, manganese, iron, other metals including lead). However, in the delivery of treated water to individual homes, contaminants can be re-introduced into the water supply. In an example, treated water passing through lead pipes connecting individual homes to a main water supply can reintroduce particles, such as lead (Pb) particles or other or other lead-based substances, into the treated water. To avoid potential adverse health effects associated with contaminated water, residents have turned to residential water treatment devices.

Several technologies exist for point-of-use (POU) treatment of water in homes. An activated carbon filer passes water through a porous carbon matrix to remove contaminants, such as by adsorption. However, the activated carbon filter is susceptible to bacterial fouling and other organic contaminants. A reverse osmosis filter passes water through a semipermeable membrane to eliminate contaminants. But reverse osmosis filters have a relatively low permeate flow rate as compared to other POU devices while back-flushing to remove accumulated contaminants is not a water efficient process. An ultraviolet (or UV) filter uses radiation to ‘disinfect’ water of organic contaminants, however, are ineffective to remove chemical contaminants.

### SUMMARY

The present inventors have recognized, among other things, that a problem to be solved can include the removal of contaminants, such as lead (Pb) or any lead-based substance, from potable water. The present subject matter can help provide a solution to this problem, such as by an apparatus and a method to remove contaminants including lead (Pb) or any lead-based substance from potable water.

The innovation can include an apparatus and method to oxidize an inorganic contaminant entrained in potable water. The method can include a step of adding an amount of at least one of hydrogen peroxide (H₂O₂), hypochlorous acid (HOCl), or chloramine (NH₂Cl) to the potable water to form a solution. The method can include a step of exposing the solution to a source of UV radiation to form a catalyst including at least one of a hydroxyl radical, a reactive chlorine species, or a reactive amine species to oxidize the inorganic contaminant.

Aspect 1 can include or use subject matter (such as an apparatus, a system, a device, a method, a means for performing acts, or an article of manufacture), such as can include or use a method to oxidize an inorganic contaminant entrained in potable water comprising, adding an amount of at least one of hydrogen peroxide (H₂O₂), hypochlorous acid (HOCl), or chloramine (NH₂Cl) to the potable water to form a solution, and exposing the solution to a source of UV radiation to form a catalyst including at least one of a hydroxyl radical, a reactive chlorine species, or a reactive amine species to oxidize the inorganic contaminant.

Aspect 2 can include or use or can optionally be combined with the subject matter of Aspect 1, to optionally include or use the method wherein the inorganic contaminant is a lead-based substance and exposing the solution includes exposing the solution to a source of UV radiation to oxidize the lead-based substance.

Aspect 3 can include or use, or can optionally be combined with the subject matter of one or any combination of Aspects 1 or 2 to optionally include or use the method wherein the inorganic contaminant is a lead-based substance, adding an amount includes adding an amount of hydrogen peroxide (H₂O₂) to the potable water to form a solution, and exposing the solution includes exposing the solution to a source of UV radiation to form a hydroxyl radical to oxidize the lead-based substance.

Aspect 4 can include or use or can optionally be combined with the subject matter of one or any combination of Aspects 1 through 3 to optionally include or use the method wherein adding an amount of hydrogen peroxide includes adding an amount of hydrogen peroxide sufficient to form a solution wherein the molar ratio of lead-based substance to hydrogen peroxide is about 1:10.

Aspect 5 can include or use or can optionally be combined with the subject matter of one or any combination of Aspects 1 through 4 to optionally include or use the method wherein exposing the solution to a source of UV radiation includes exposing the solution to UV radiation with a wavelength in a range of about 10 nanometers to about 400 nanometers.

Aspect 6 can include or use or can optionally be combined with the subject matter of one or any combination of Aspects 1 through 5 to optionally include or use the method wherein exposing the solution to a source of UV radiation includes exposing the solution to UV radiation with a wavelength of about 254 nanometers.

Aspect 7 can include or use or can optionally be combined with the subject matter of one or any combination of Aspects 1 through 6 to optionally include or use the method wherein exposing the solution to a source of UV radiation includes exposing the solution to UV radiation for an amount of time in a range of about 0.01 seconds to about 10 minutes.

Aspect 8 can include or use or can optionally be combined with the subject matter of one or any combination of Aspects 1 through 7 to optionally include or use the method comprising adjusting the solution pH to a range of about 6 to about 8 before exposing the solution to the source of UV radiation.

Aspect 9 can include or use subject matter (such as an apparatus, a system, a device, a method, a means for performing acts, or a device readable medium including instructions that, when performed by the device, can cause the device to perform acts, or an article of manufacture), such as can include or use a method to remove an inorganic contaminant entrained in potable water, comprising adding an amount of at least one of hydrogen peroxide (H₂O₂), hypochlorous acid (HOCl), or chloramine (NH₂Cl) to the potable water to form a solution, exposing the solution to a source of UV radiation to form a catalyst including at least one of a hydroxyl radical, a reactive chlorine species, or a reactive amine species to oxidize the inorganic ion, and filtering the solution to remove the oxidized inorganic contaminant from the solution.

Aspect 10 can include or use or can optionally be combined with the subject matter of Aspect 9, to optionally include or use the method wherein the inorganic contaminant is a lead-based substance, exposing the solution includes exposing the solution to a source of UV radiation to oxidize the lead-based substance, and filtering the solution includes mechanically filtering the solution to remove the oxidized lead-based substance from the solution.

Aspect 11 can include or use or can optionally be combined with the subject matter of one or any combination of Aspects 9 or 10 to optionally include or use the method wherein the inorganic contaminant is a lead-based substance, adding an amount includes adding an amount of hydrogen peroxide (H₂O₂) to the potable water to form a solution; and exposing the solution includes exposing the solution to a source of UV radiation to form a hydroxyl radical to oxidize the lead-based substance.

Aspect 12 can include or use or can optionally be combined with the subject matter of one or any combination of Aspects 9 through 11 to optionally include or use the method wherein adding an amount of hydrogen peroxide includes adding an amount of hydrogen peroxide sufficient to form a solution wherein the molar ratio of lead-based substance to hydrogen peroxide is about 1:10.

Aspect 13 can include or use or can optionally be combined with the subject matter of one or any combination of Aspects 9 through 12 to optionally include or use the method wherein exposing the solution to a source of UV radiation includes exposing the solution to UV radiation with a wavelength in a range of about 10 nanometers to about 400 nanometers.

Aspect 14 can include or use or can optionally be combined with the subject matter of one or any combination of Aspects 9 through 13 to optionally include or use the method wherein exposing the solution to a source of UV radiation includes exposing the solution to UV radiation with a wavelength of about 254 nanometers.

Aspect 15 can include or use subject matter (such as an apparatus, a system, a device, a method, a means for performing acts, or a device readable medium including instructions that, when performed by the device, can cause the device to perform acts, or an article of manufacture), such as can include or use a method to remove a lead-based contaminant entrained in potable water, comprising adding an amount of hydrogen peroxide (H₂O₂) sufficient to form a solution with a molar ratio of about 1:10 lead based-contaminant to hydrogen peroxide, exposing the solution to a source of UV radiation with a wavelength of about 254 nanometers to form a hydroxyl radical catalyst to oxidize the lead-based contaminant; and mechanically filtering the solution to remove the oxidized lead-based contaminant from the solution.

Each of these non-limiting examples can stand on its own or can be combined in various permutations or combinations with one or more of the other examples.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example of an apparatus, such as to remove contaminants from potable water.

FIG. 2 shows an example method to remove contaminants from potable water, such as with the apparatus.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

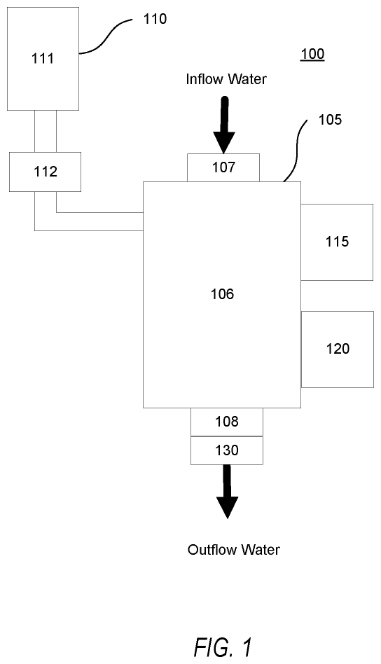

FIG. 1 shows an example of an apparatus 100, such as to remove contaminants from potable water. Removal of contaminants can include a process utilizing the apparatus 100. The apparatus 100 can include at least one of a reactor 105, a reservoir 110, an agitator 115, an energy source 120, or a filter 130.

The reactor 105 can include a vessel, such as a first vessel, to define a reactor volume 106. The reactor 105 can include a reactor inlet 107, such as to receive inflow water from a source of water including a municipal water source, into the reactor volume 106. In an example, inflow water can include potable water. The reactor 105 can include a reactor outlet 108, such as to allow water to exit from the reactor volume 106.

The reservoir 110 can include a vessel, such as a second vessel, to define a reservoir volume 111. The reservoir 110 can be in communication with the reactor 105, such as the reservoir volume 111 can be in communication with the reactor volume 106. The reservoir 110 can be configured to hold a material, such as a dry material including a granular material or an aqueous material. In an example, the reservoir 110 can be configured to hold a precursor material, such as a precursor chemical including at least one of a hydrogen peroxide, a chlorine, or a chloramine. In an example, chloramine can include at least one of an organic chloramine or an inorganic chloramine.

The reservoir 110 can include a metering valve 112, such as located in communication with the reactor 105 and the reservoir 110. The metering value 112 can dispense an amount of material, such as from the reservoir volume 111 into the reactor volume 106, to form a solution in the reactor volume 106. In an example, the metering value 112 can control the amount of material transferred from the reservoir volume 111 into the reactor volume 106, such as to form a solution with a target molar ratio.

The agitator 115 can be in communication with the reactor 105, such as the reactor volume 106. The agitator 115 can promote intermixing within the reservoir volume 106, such as intermixing of the inflow water and the precursor chemical. The agitator 115 can be configured to promote active intermixing within the reservoir volume, such as through the introduction of energy including at least one of mechanical energy, electrical energy, or chemical energy, into the reactor volume 106.

The agitator 115 can include a pressure source, such as a pump including a pump inlet to receive water and a pump outlet to expel water. In an example, the pressure source can be located in communication with the reactor volume 106. The pressure source can be configured to draw at least one of inflow water or the precursor chemical from the reservoir volume into the pump inlet and expel the at least one of inflow water or the precursor chemical back into the reactor volume 106, such as to generate turbulence within the reactor volume 106 to promote intermixing of the inflow water and the precursor chemical.

The agitator 115 can include an impeller, such as an impeller connected to an electric motor configured to cause the impeller to move. In an example, the impeller can be located in communication with the reactor volume 106. The impeller can be configured to move, such as spin, within the reactor volume 106, such as to generate turbulence within the reactor volume 106 to promote intermixing of the inflow water and the precursor chemical.

The agitator 115 can be configured to promote passive intermixing within the reservoir volume, such as through appropriate design of the reactor volume 106. The reactor volume 106 can include a baffle, such as in contact with at least at least one of inflow water or the precursor chemical. In an example, the flow of inflow water into the reactor volume 106, such as flow under pressure from a municipal water source through the reactor inlet 107, can impinge upon the baffle and experience redirection, such as redirection from a first direction of flow prior to contact with the baffle to a second direction of flow different from the first direction of flow after contact with the baffle, to create turbulence within the reactor volume 106.

The energy source 120 can be in communication with the reactor 105, such as the reactor volume 106. The energy source 120 can be located in communication with the reactor 105 and can be configured to deliver an amount of energy to the reactor volume 106. In an example, the amount of energy can include an approximately uniform amount of energy, such as delivered by an energy source 120 configured to uniformly irradiate the volume of the reactor volume 106.

The energy source 120 can include an ultraviolet (or UV) energy source, such as an energy source 120 configured to emit energy at a wavelength in the UV spectrum. The wavelength can include a range of wavelengths, such wavelengths in the range of about 10 nm to about 400 nm. In an example, the range of wavelengths can include a range of about 250 nm to about 300 nm. In an example, the wavelength can include a wavelength of about 254 nm.

The energy source 120 can be configured to introduce energy into the reactor volume 106, such as an activation energy level or energy sufficient to activate the precursor chemical intermixed in the solution. The activation energy level can induce a reaction in the solution, such as a precursor dissociation reaction, to generate a free radical catalyst from the precursor chemical.

The precursor dissociation reaction can generate one or more free radical catalyst. In an example, a precursor dissociation reaction can include creation of a hydroxyl radical (HO·) catalyst from a precursor hydrogen peroxide, such as in the solution. In an example, a precursor dissociation reaction can include creation of a reactive chlorine species (Cl· and Cl₂·′) catalyst and a hydroxyl radical (HO·) catalyst from a precursor free chlorine, such as in the solution. In an example, a precursor dissociation reaction can include creation of a reactive chlorine species (Cl· and Cl₂·′) catalyst, a hydroxyl radical (HO·) catalyst, and a reactive amine species (NH₂· and others) catalyst from a precursor chloramine, such as in the solution. A list of reactions, such as an example precursor dissociation reaction list, is included in this application in a section titled Selected UV Catalytic Reactions.

The free radical catalyst can oxidize a contaminant in the solution, such as an inorganic contaminant. The resultant oxidized contaminant can be changed in size, such as increased in size, and can agglomerate with other contaminants including other oxidized contaminants, such as due to changed surface chemistry and morphology associated with the oxidation contaminant. The oxidized contaminant can be entrained in the solution within the reactor volume 206.

The energy source 120 can include an energy control system, such as in communication with the energy source 120. The energy control system can include a sensor, such as a sensor configured to sense an indication related to at least one of the apparatus 100 or the method 200.

The indication can include at least one of an indication of the inflow water into the reactor 105. In an example, an inflow water indication can include an indication of level for at least one of a water velocity, a water volume, inlet water pressure, water temperature, water pH, chloride, carbonate, or contaminant including lead (Pb) or any lead-based substance.

The indication can include at least one of an indication of the solution, such as the precursor solution. In an example, a solution indication can include an indication of level for at least one of amount of free radical catalyst, pressure, temperature, pH, chloride, carbonate, or contaminant including lead (Pb) or any lead-based substance.

The indication can include at least one of an indication of the outflow water from the reactor 105. In an example, an outflow water indication can include an indication of level for at least one of velocity, volume, outlet pressure, temperature, pH, chloride, carbonate, contaminant including lead (Pb) or any lead-based substance, or an oxidized contaminant.

The energy control system can include control circuitry, such as to monitor and control operation of the apparatus 100. In an example, the control circuitry can be configured to receive an indication from a sensor, such as a sensor configured to sense an indication related to at least one of the apparatus 100 or the method 200. In an example, the control circuitry can be configured to control exposure of the solution to the energy source 120, such as based on at least one of a target molar ratio, a target solution pH level, a target solution chloride level, a target carbonate species level, a target UV wavelength, or a target activation energy level.

The filter 130 can be in communication with the reactor 105, such as connected to the reactor outlet 108. The filter 130 can include a mechanical filter, such as at least one of a screen or a semi-permeable membrane. In an example, the pore size of the filter 130 can be selected to collect a contaminant, such as at least one of an oxidized contaminant or an agglomerated contaminant entrained in the outflow water exiting the reactor 105 through the reactor outlet 108.

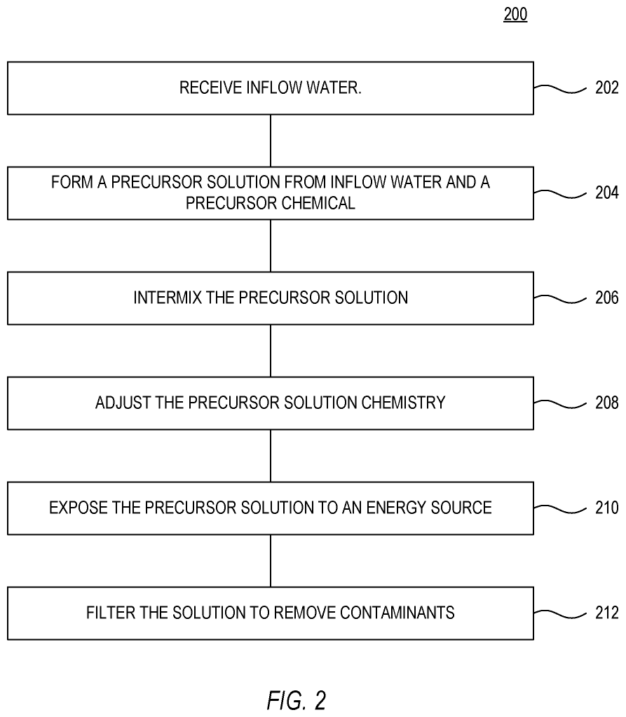

FIG. 2 shows an example method 200 to remove contaminants from potable water, such as with the apparatus 100. In an example, water, such as inflow water with a contaminant including an inorganic contaminant, can be received into the reactor 105. In an example, the received water can be combined with a precursor chemical, such as delivered from a reservoir 110, to form a solution. The precursor chemical can be metered, such as with a metering valve 112 located between the reservoir 110 and the reactor 105, to control the amount of precursor chemical introduced into the solution. In an example, an agitator 115 can intermix the solution, such as to distribute the precursor chemical more thoroughly in the solution. In an example, the solution chemistry can be adjusted, such as to condition the solution for exposure to an energy source 120. In an example, the solution can be exposed to an energy source 120, such as a UV energy source. The UV energy source can irradiate the solution in the reactor 105, such as to activate the precursor intermixed within the solution. Activation of the precursor can produce a catalyst, such as a free radical catalyst including a highly reactive radical species, to interact with the contaminant entrained in the solution, such as to oxidize the contaminant. The catalyst process, such as the oxidation process, can change the morphology of the catalyzed contaminant, such as to cause agglomeration of the catalyzed contaminant with another contaminant in the solution including another catalyzed contaminant. In an example, aggregated particulate, such as a particulate formed by the agglomeration of one or more contaminants within the solution, can be removed from the solution, such as by a filter 130 used to screen the aggregated particulate from the outflow water exiting the reactor 105.

At 202, inflow water can be received, such as with the reactor volume 106 of the apparatus 100. The received water can contain a contaminant, such as at least one of physical, organic, or chemical contaminant. In an example, a chemical contaminant can include at least one of a lead-based substance, such as lead oxide (Pb(II)) or lead phosphate (Pb₃(PO₄)₂), a dissolved iron (Fe(II)), a dissolved manganese (Mn(II)), or a dissolved arsenic (As(III)).

At 204, a solution can be formed, such as a precursor solution. The precursor solution can be formed by combining the inflow water, such as received with the reactor volume 106, and adding an amount of material from the reservoir 110, such as an amount of a precursor chemical. In an example, a precursor chemical can include at least one of a hydrogen peroxide, a chlorine, or a chloramine. In an example, chloramine can include at least one of an organic chloramine or an inorganic chloramine.

The amount of precursor chemical added to the inflow water can be controlled, such as with the metering valve 112. Controlling the type and amount of precursor added to inflow water can affect the composition of the precursor solution, such as to influence the number of free radicals available to interact with contaminants in the solution.

Adding an amount of material can include adding an amount of precursor chemical to achieve a target molar ratio. In an example, a target molar ratio can include a contaminant-to-precursor molar ratio in a range of about 1:5 (one part contaminant to 5 parts precursor) to about 1:20 (one part contaminant to 20 parts precursor). In an example, a target molar ratio can include a contaminant-to-precursor molar ratio of about 1:10 (one part contaminant to 10 parts precursor).

At 206, the solution can be intermixed, such as to distribute the precursor chemical in the inflow water. Intermixing can include at least one of active intermixing or passive intermixing.

Intermixing can include active intermixing, such as intermixing with an agitator 115 in communication with the reactor volume. In an example an agitator can include at least one of a pump or an impeller, such as an impeller attached to a motor.

Intermixing can include passive intermixing, such as natural intermixing due to flow of the inflow water including intermixing due to inflow water turbulence. Passive intermixing can include shaping the reactor volume, such as to promote turbulence of a material located in the reactor volume. In an example, the reactor volume can include a baffle, such as to redirect inflow water within the reactor volume 106 to increase turbulence within the reactor volume due to the velocity of the inflow water.

At 208, the chemistry of the solution can be adjusted. Solution chemistry can be adjusted to optimize a reaction or process, such as a catalyst process including an oxidation process. In an example, at least one of a pH level, a chloride level, or a carbonate species level of the solution can be adjusted.

Adjusting solution chemistry can include adjusting the pH level of the solution. In an example, adjusting the pH level can include adding an amount of solute, such as to adjust the solution pH level toward a target solution pH level. In an example, a solute can include at least one of perchloric acid (HClO₄) or sodium hydroxide (NaOH). In an example, a target solution pH level can include a target solution pH level of about 7. In an example, a target solution pH level can include a target solution pH range, such as a target solution pH range of about pH=6 to about pH=9.

Adjusting solution chemistry can include adjusting the chloride level of the solution. In an example, adjusting the chloride level can include adding an amount of solute, such as to adjust the solution chloride level toward a target solution chloride level. In an example, a target solution chloride level can include a target chloride range, such as at least one of a target chloride range of about 0 milligrams per liter to about 50 milligrams per liter or a target chloride range of about 15 milligrams per liter to about 35 milligrams per liter.

Adjusting solution chemistry can include adjusting the carbonate species level of the solution. In an example, adjusting the carbonate species level can include adding an amount of solute to adjust the solution carbonate species level toward a target solution carbonate species level. In an example, a target solution carbonate species level can include a target carbonate species range, such as at least one of a target carbonate species range of about 0 milligrams per liter to about 200 milligrams per liter or a target carbonate species range of about 50 milligrams per liter to about 150 milligrams per liter.

At 210, the solution can be exposed to an energy source 120, such as an ultraviolet (UV) energy source. Exposure of the solution, such as the precursor solution, to the UV energy source can create a free radical catalyst, such as from a precursor chemical in the precursor solution. In an example, a UV energy source can include at least one of a mercury vapor lamp or an ultraviolet light emitting diode (UV LED), such as a tunable UV LED.

Exposing the solution can include exposing the solution to a UV energy source emitting energy at a UV wavelength, such as a target UV wavelength. In an example, the target UV wavelength can include a wavelength of about 254 nm. A target UV wavelength can include a target UV wavelength range. In an example, a target UV wavelength range can include at least one of a wavelength range of about 10 nm to about 400 nm or a wavelength range of about 250 nm to about 300 nm.

Exposing the solution can include exposing the solution to a UV energy source emitting energy at an energy level, such as an activation energy level. Application of an activation energy level to the solution can initiate a precursor dissociation reaction, such as to create a free radical catalyst in the solution. The activation energy level can be expressed with a unit, such as at least one of a unit of energy including joules (e.g., millijoules), a unit of energy per unit area (e.g., millijoules per centimeter square), or a unit of energy per unit volume (e.g., energy density, millijoules per centimeter cubed).

Exposing the solution can include exposing the solution to an activation energy level, such as a target activation energy level. The target activation energy level can include a level of energy to create free radical catalyst sufficient to oxidize a specified amount of contaminant, such as a percentage of the contaminant in the solution. In an example, the target activation energy level can include an energy level required to create free radical catalyst sufficient to oxidize a contaminant in the reactor volume 106, such as at least one of an energy level to oxidize about 50% of the contaminant, an energy level to oxidize about 60% of the contaminant, an energy level to oxidize about 70% of the contaminant, an energy level to oxidize about 80% of the contaminant, an energy level to oxidize about 90% of the contaminant, or an energy level to oxidize about 100% of the contaminant.

Exposing the solution can include exposing the solution to a UV energy source, such as for a specified amount of time. The amount of energy transferred from the energy source 120 to the solution can depend on the intensity of the energy source 120 and the exposure time, such as the time the solution is exposed to the energy source 120. In an example, the solution can be exposed to a source of UV radiation, such as in a range of about 0.01 seconds to about 10 minutes. In an example, the solution can be exposed to the source of UV radiation for about 5 minutes.

Exposing the solution can include exposing the solution to a UV energy source, such as at a specified intensity. The amount of energy transferred from the energy source 120 to the solution can depend on the intensity of the energy source 120, such as the power per unit area, and the exposure time. In an example, the solution can be exposed to a source of UV radiation, such as with energy per unit area in a range of about 10 mJ/cm2 to about 100 mJ/cm2. In an example, exposing the solution can include exposing the solution to a UV energy source, such as a UV energy source radiating energy at 85 mJ/cm2 for about 5 minutes.

At 212, the solution can be filtered, such as to remove contaminants from the outflow stream. Filtering the outflow stream can include selecting an appropriate filter pore size to remove contaminants, such as oxidized contaminants.

### Selected UV Catalytic Reactions

Reactions that generate free radicals catalyst precursors during UV irradiation:

Generation of hydroxyl radical (HO·) catalyst from precursor hydrogen peroxide:

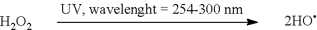

Generation of reactive chlorine species (Cl· and Cl₂·′) and hydroxyl radical (HO·) catalysts from precursor free chlorine:

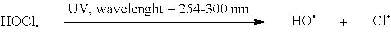

Cl·+Cl⁻→Cl₂·⁻

Cl₂·⁻+H₂O→HO·+H⁺+2Cl⁻

Generation of reactive chlorine species (Cl· and Cl₂·⁻), hydroxyl radical (HO·) and reactive amine species (NH₂· and others) catalysts from precursor chloramine.

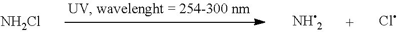

Cl·+Cl⁻→→Cl₂·⁻

Cl₂·⁻+H₂O→HO^{·}+H⁺+2Cl⁻

Reactions that convert dissolved Pb²⁺ ions in feed water to particulate Pb⁴⁺ solid lead dioxide PbO₂₍ₛ₎ by the catalysts of radical soup mixture:

2HO·+Pb²⁺+2O H⁻→PbO₂₍ₛ₎+2H₂O

2Cl·+Pb²⁺+4OH⁻→PbO₂₍ₛ₎+2H₂O+2Cl⁻

2Cl₂·⁻+Pb²⁺+4OH⁻→PbO₂₍ₛ₎+2H₂O+4Cl⁻

2NH₂·+Pb²⁺+2OH⁻→PbO₂₍ₛ₎+2NH₃

### Various Notes

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method to oxidize an inorganic contaminant entrained in potable water comprising:
adding an amount of at least one of hydrogen peroxide (H₂O₂), hypochlorous acid (HOCl), or chloramine (NH₂Cl) to the potable water to form a solution; and
exposing the solution to a source of UV radiation to form a catalyst including at least one of a hydroxyl radical, a reactive chlorine species, or a reactive amine species to oxidize the inorganic contaminant.

2. The method of claim 1, wherein the inorganic contaminant is a lead-based substance and exposing the solution includes exposing the solution to a source of UV radiation to oxidize the lead-based substance.

3. The method of claim 1, wherein the inorganic contaminant is a lead-based substance,
adding an amount includes adding an amount of hydrogen peroxide (H₂O₂) to the potable water to form a solution; and
exposing the solution includes exposing the solution to a source of UV radiation to form a hydroxyl radical to oxidize the lead-based substance.

4. The method of claim 3, wherein adding an amount of hydrogen peroxide includes adding an amount of hydrogen peroxide sufficient to form a solution wherein the molar ratio of lead-based substance to hydrogen peroxide is about 1:10.

5. The method of claim 1, wherein exposing the solution to a source of UV radiation includes exposing the solution to UV radiation with a wavelength in a range of about 10 nanometers to about 400 nanometers.

6. The method of claim 5, wherein exposing the solution to a source of UV radiation includes exposing the solution to UV radiation with a wavelength of about 254 nanometers.

7. The method of claim 1, wherein exposing the solution to a source of UV radiation includes exposing the solution to UV radiation for an amount of time in a range of about 0.01 seconds to about 10 minutes.

8. The method of claim 1, comprising adjusting the solution pH to a range of about 6 to about 8 before exposing the solution to the source of UV radiation.

9. A method to remove an inorganic contaminant entrained in potable water, comprising:
adding an amount of at least one of hydrogen peroxide (H₂O₂), hypochlorous acid (HOCl), or chloramine (NH₂Cl) to the potable water to form a solution;
exposing the solution to a source of UV radiation to form a catalyst including at least one of a hydroxyl radical, a reactive chlorine species, or a reactive amine species to oxidize the inorganic contaminant; and
filtering the solution to remove the oxidized inorganic contaminant from the solution.

10. The method of claim 9, wherein the inorganic contaminant is a lead-based substance, exposing the solution includes exposing the solution to a source of UV radiation to oxidize the lead-based substance, and filtering the solution includes mechanically filtering the solution to remove the oxidized lead-based substance from the solution.

11. The method of claim 9, wherein the inorganic contaminant is a lead-based substance,
adding an amount includes adding an amount of hydrogen peroxide (H₂O₂) to the potable water to form a solution; and
exposing the solution includes exposing the solution to a source of UV radiation to form a hydroxyl radical to oxidize the lead-based substance.

12. The method of claim 11, wherein adding an amount of hydrogen peroxide includes adding an amount of hydrogen peroxide sufficient to form a solution wherein the molar ratio of lead-based substance to hydrogen peroxide is about 1:10.

13. The method of claim 9, wherein exposing the solution to a source of UV radiation includes exposing the solution to UV radiation with a wavelength in a range of about 10 nanometers to about 400 nanometers.

14. The method of claim 13, wherein exposing the solution to a source of UV radiation includes exposing the solution to UV radiation with a wavelength of about 254 nanometers.

15. A method to remove a lead-based contaminant entrained in potable water, comprising:
adding an amount of hydrogen peroxide (H₂O₂) sufficient to form a solution with a molar ratio of about 1:10 lead-based contaminant to hydrogen peroxide;
exposing the solution to a source of UV radiation with a wavelength of about 254 nanometers to form a hydroxyl radical catalyst to oxidize the lead-based contaminant; and
mechanically filtering the solution to remove the oxidized lead-based contaminant from the solution.
